(19) United States
(12) Patent Application Publication
(10) Pub. No.: US 2015/0197457 A1
(43) Pub. Date: Jul. 16, 2015

(54) Flatbed Energy Biomass to Char Conversion Apparatus and Methods of Use

(71) Applicants: Jim Aldridge, Palo Alto, CA (US); David Correja, Fremont, CA (US)

(72) Inventors: Jim Aldridge, Palo Alto, CA (US); David Correja, Fremont, CA (US)

(21) Appl. No.: 14/506,589

(22) Filed: Oct. 3, 2014

Related U.S. Application Data
(60) Provisional application No. 61/886,232, filed on Oct. 3, 2013.

(51) Int. Cl. C05B 17/00; C10L 5/44; C05D 1/00; C05F 11/00; C05D 9/02; C05C 11/00; C10L 5/42; C10L 5/46

(52) U.S. Cl. CPC C05B 17/00; C10L 5/42; C10L 5/445; C10L 5/46; C05F 11/00; C05D 9/02; C05C 11/00; C05D 1/00; C10L 2200/0469; C10L 2250/02; C10L 2290/06; C10L 2290/24; C10L 2290/567

(57) ABSTRACT

The invention relates to a biomass conversion machine that converts biomass to char with high concentrations of water in an oxygen deficient or oxygen-free environment. The biomass conversion machine is designed to be movable via typical roadways, railways, or waterways.

### CROSS-REFERENCE TO RELATED APPLICATIONS

This application claims the benefit of U.S. Provisional Application No. 61/825,987, filed Oct. 3, 2013, such application is incorporated herein by reference in its entirety.

### FIELD OF THE INVENTION

The present invention relates to an apparatus for generating energy from biomass and methods of using such an apparatus in remote or portable applications.

### DESCRIPTION OF THE RELATED ART

The vast majority of fuels are distilled from crude oil pumped from limited underground reserves. As the earth's crude oil supplies are depleted, the world-wide demand for energy is simultaneously growing. Depletion of the remaining world's easily accessible crude oil reserves will lead to a significant increase in cost for fuel obtained from crude oil.

The search to find processes that can efficiently convert industrial waste, depleteable materials, and renewable materials to fuels and by products suitable for transportation and/or heating is an important factor in meeting the ever-increasing demand for energy. In addition, processes that have solid byproducts that have improved utility are also increasingly in demand.

Solid byproducts by process that have more beneficial properties are an important factor in meeting the ever-increasing demand for energy and food. The present invention fulfills these needs and provides various advantages over the prior art. A further problem solved through the present invention is the ability to bring the reactor to the biomass source, allowing for synergistic remediation and resource generation on-site.

### SUMMARY OF THE INVENTION

The present embodiments address the needs discussed herein for a portable apparatus and process for converting biomass to resources, including char (energy) and water.

One preferred embodiment is a method for producing a biochar mass comprising the steps of: introducing a biomass to a reactor; and heating the biomass in the reactor in accordance with a predetermined set of operating parameters attuned to the biomass to produce a stable biochar core, wherein said heating is done in an aqueous solution under oxygen deficient conditions.

In one embodiment, the biomass includes a plant derived material and/or an animal product. In another, the predetermined set of operating parameters includes a time-dependent temperature profile that corresponds to the selected type of biochar core.

In an embodiment the predetermined set of operating parameters includes an established temperature range and rate of temperature change that corresponds to the selected type of biochar core.

The process may further comprise at least one of blending the biochar core with organic matter, annealing, or activation and may further comprise mixing the biochar with a supplement to produce a functionalized biochar core.

In an embodiment the supplement includes a microbe, a nutrient, a fertilizer, or any combination thereof or may include nutrients comprising nitrogen, phosphorus, potassium, selenium, cobalt, iron, or manganese.

Preferably the reactor and system is sized to be movable via common roadways and the biochar has a rate of degradation that is less than 2.5% per year, which may be determined by measuring the loss of carbon. In some embodiments the biomass may be heated under oxygen-free conditions.

In one embodiment the system is operated where the biomass is heated in a porous pipe wherein steam is injected into the pipe, the biomass is moved through said pipe in a continuous feed system, said operating parameters being a function of the heating conditions, the length of pipe, and composition of feedstock biomass.

Herein, “Char” is a char composition made from an organic-carbon-containing feedstock that passes through a microwave process system is described. The system includes at least one reaction chamber within system. At least one reaction cavity exists within the reaction chamber configured to hold the organic-carbon-containing feedstock in an externally supplied oxygen free atmosphere, in one embodiment. The resulting char composition includes substantially no free water. Also preferably, the char composition includes pores that have a variance in pore size of less than 10 percent.

In another embodiment, the char composition of the invention involves a reactor process for converting an organic-carbon-containing compound to fuel, water and char. An organic-carbon-containing feedstock is input into a reaction chamber containing no externally supplied oxygen. Energy is directed to impinge on the feedstock. The feedstock is reacted until it produces a fuel and the char composition.

The above summary is not intended to describe the char in every detail. Characteristics and benefits over known char made by the thermal processing of the same organic-carbon-containing feedstocks, together with a more complete understanding of the invention, will become apparent and appreciated by referring to the following detailed description and claims taken in conjunction with the accompanying drawings.

As used herein:

“Biochar” is made by “renewable material feedstock” processed in the reactor as described in this document.

“Organic-carbon-containing feedstock” means “renewable material feedstock” and “unrenewable material feedstock” containing organic carbon.

“Char” means the solid product of the devolitization of “organic-carbon-containing feedstock” processed in the reactor as described in this document.

“Renewable material feedstock” means organic-carbon-containing feedstock from plant or animal material that can be renewed in less than 50 years, for example, and includes such materials as, for example, grasses, agricultural plant waste, tree parts, animal manure, and the like.

“Unrenewable material feedstock” means hydrocarbon-containing feedstock that includes manufactured material and depletable plant and animal material that cannot be renewed in less than 50 years, and includes such materials as, for example, rubber such as tire crumbs, plastics, municipal waste, crude oil, peat, and coal such as bituminous coal, and anthracite coal.

### BRIEF DESCRIPTION OF THE DRAWING

FIG. 1 depicts an embodiment of the apparatus and system.

FIG. 2 depicts an embodiment of the apparatus and system from a different perspective.

FIG. 3 depicts an embodiment of the apparatus and system from a different perspective.

FIG. 4 depicts an embodiment of the apparatus and system from a different perspective.

FIG. 5 is a flow diagram describing an embodiment process.

### DETAILED DESCRIPTION OF PREFERRED EMBODIMENTS

The preferred embodiments of the portable, biomass conversion apparatus and methods of use is disclosed herein. Other variations and features known to those of skill in the art may be used with and in conjunction with the embodiments described and disclosed herein without straying from the scope of the invention.

The biomass conversion machine converts biomass containing high concentrations of water intochar fuel, a replacement for fossil fuels. Other uses for biochar include using it as a soil additive to improve crop yields. This system will process all farm and sanitary municipal waste including agriculture plants, animal and human waste. This machine can scale to fit on 40 ft flatbed trailer or be built into a stationary utility sized plant.

This process converts biomass waste into a dense renewable energy fuel that has low emissions when combusted as a fuel with the advantage of being carbon neutral. Further using our machine on animal waste cleans up a severe problem with animal manure polluting clean water sources on farm land. In addition, unlike most systems which need the moisture of the biomass to be less than 15%, this system has a continuous process that converts biomass with moisture content over 90%.

Some features of the preferred embodiments are that the apparatus: cooks biomass at high temperature without air in a solution of water very fast; is compact and portable, preferably designed on a movable platform; the apparatus is self-powering; the apparatus preferably is operated in a continuous plug flow process in a heated pipe using a continuous feed system under automated computer control; the apparatus produces multiple utilizable resources, incluging energy, water, and waste heat; and has a linear heating profile along a pipe with peak heat in middle.

Some benefits of the preferred embodiments are: the system is ideal for animal waste, offering additional benefits in remediating a waste product and converting it to useful resources; the size of the system is fully scalable in both parallel and series, making possible a mobile sized to utility scale; the system is self-powers and runs autonomously; the system is customizable through programming the system to process different types and conditions of biomass; and the system essentially returns essentially all of the water in the biomass.

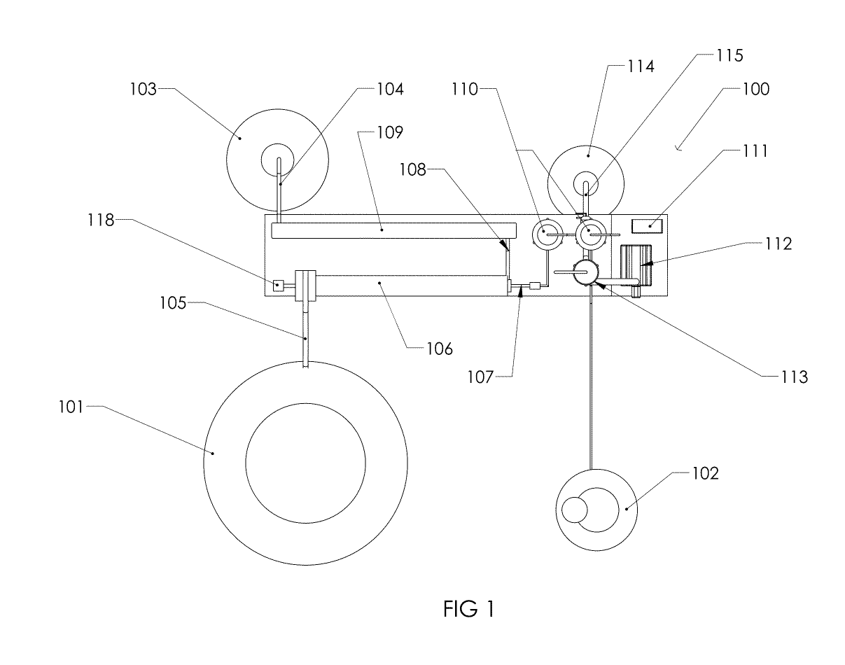

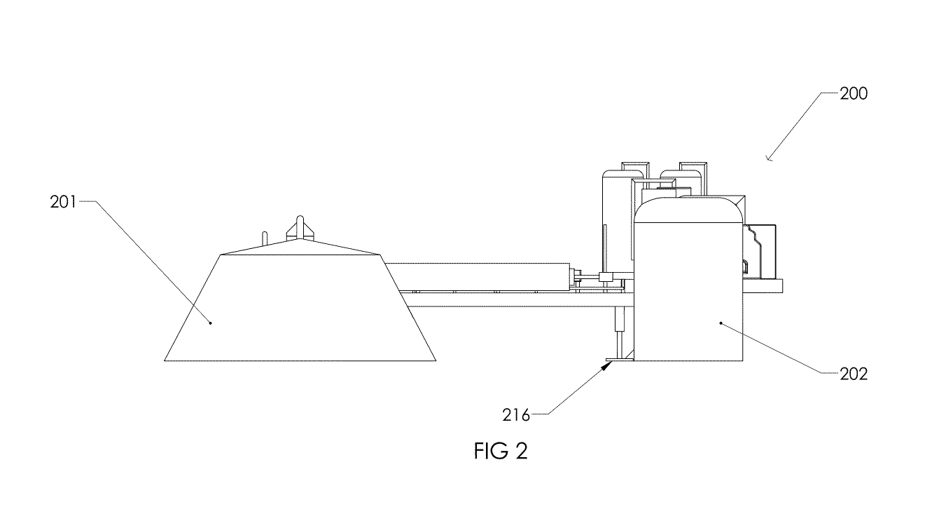

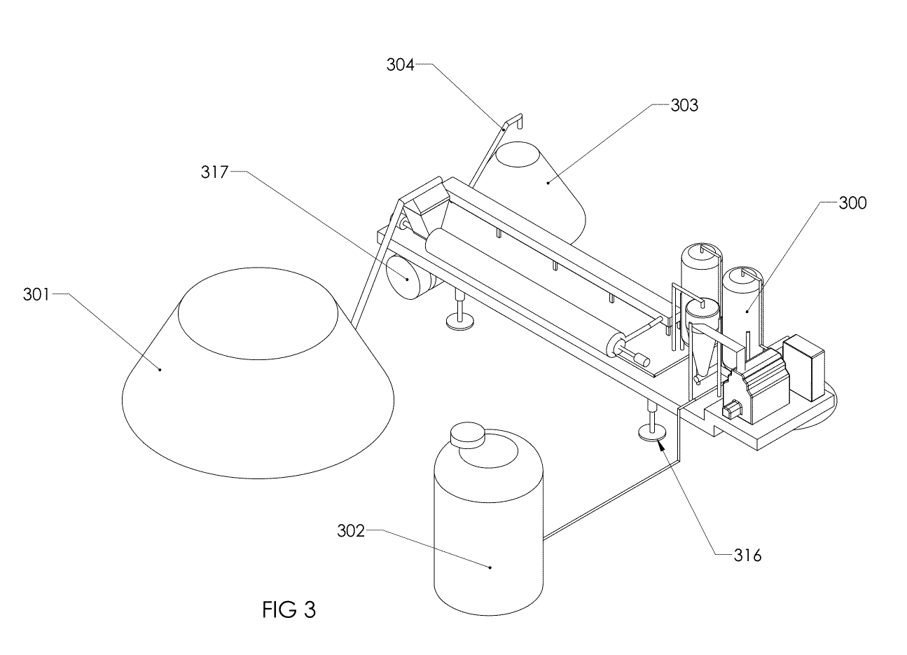

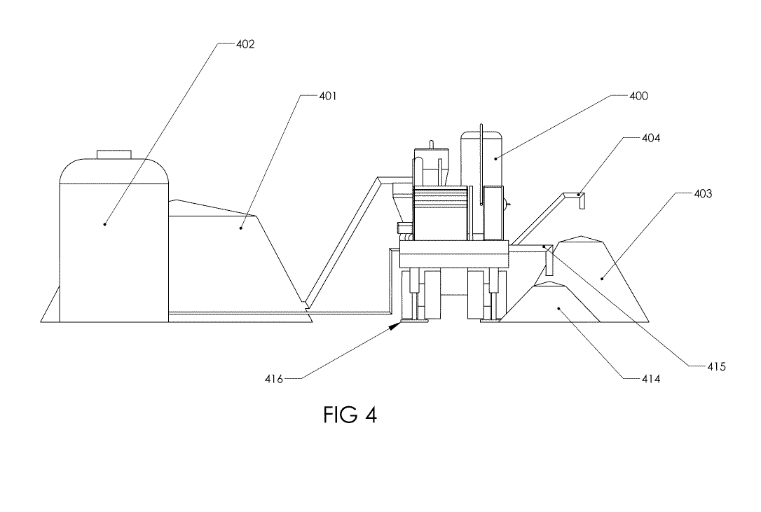

A preferred embodiment is displayed in FIGS. 1-4. In the figures, the numbers correspond to the same item but numbered corresponding to the figure number. For example, 101 is the same as 201, which is the same as 301 and 401 but shown in different perspectives. 101 is a feedstock pile loaded with a front loaded tractor at the site. This pile auto-feeds into the machine and will be reloaded every 24 hours. 102 is a water tank that stores produced in the process. In a preferred embodiment, the tank will store production of water from 24 hours of operation and will provide for once per day maintenance. 103 is the product pile of dried char pellets. In a preferred embodiment, the pile may be uncovered is summer but in winter it may be stored in a hopper. This pile is easy to transfer with a front loader tractor or otherwise. 104 is a product conveyer from the drying oven to the product pile. This conveyer moves the finished dry pellet with minimal damage and can handle the flakes and dust from the product. 105 is a feedstock conveyer from the feed pile to the feed hopper. In a preferred embodiment the conveyer will collect material from the pile and preheat to feed into the first stage of the reactor. 106 It is also preferred for the reactor to be operate as a plug flow reactor where feedstock is forced in one end, then heated at a positive pressure to cook and form the final product. In the embodiment, the reactor does the transformation chemistry to reduce the water content of the feed stock, thereby increasing the heat value of the char product. This is important because the reactor heats, holds pressure and moves the product thru at constant temperature. 107 is the exit of the reactor which acts to press the product into pellets and separate the liquid and solids. This stage reduces the energy and time it takes to dry the product. It also generates water to be used after it is filtered, for example, for agricultural purposes or other recycled water uses. 108 is the pressed conveyer from the pellet press to the drying chamber. With this conveyer the moist product is transferred from a hot wet environment to a hot dry chamber where the product moisture is reduced to under 2% water by weight. 109 is the drying chamber to dry the product. 110 indicates the filters used to clean the generated water and allow the water to be used for other purposes. 111 is a liquid-to-air heat exchanger used in the process to dissipate heat from the system. The exchanger keeps the machine from overheating. 112 is the solid fuel steam boiler that supplies power to power the electrical and motion systems. The boiler takes the product solid fuel and converts it to power, that heats the reactor and dryer chamber, the boiler also may be used to run a steam engine that drives a hydraulic pump and electric generator. 113 is a fly ash air separator that removes the ash from the steam boiler exhaust gas, for example, for environmental purposes. The separator keeps the ash out of the air reducing air born particles and also allows the ash to be collected and used as a soil fertilizer. 114 shows the wet fly ash pile. Wetting the ash prevents it from easily blowing in the wind. it does not blow easily. 115 is the fly ash conveyer. 116 depicts the trailer footing is also depicted in FIGS. 1-4, in a preferred embodiment are at least four footings to support the trailer, for example, on wet soil, and level the trailer and take the operating weight off the tires. The footing 116 preferably will have a large area to distribute the weight over a greater surface area of soil for stability purposes. The feet further may keep the machine from listing and rolling over in wet weather conditions. The footing further distributes the operating weight off the tires. 117 depicts the trailer tires. These are part of the trailer and allow the system to be moved to the fuel sites easily. 118 is the feed stock hydraulic ram. In a preferred embodiment, the hydraulic ram is used to push raw material, feedstock, into the reactor chamber. The ram takes the material from room pressure and delivers it into the reactor at high pressure.

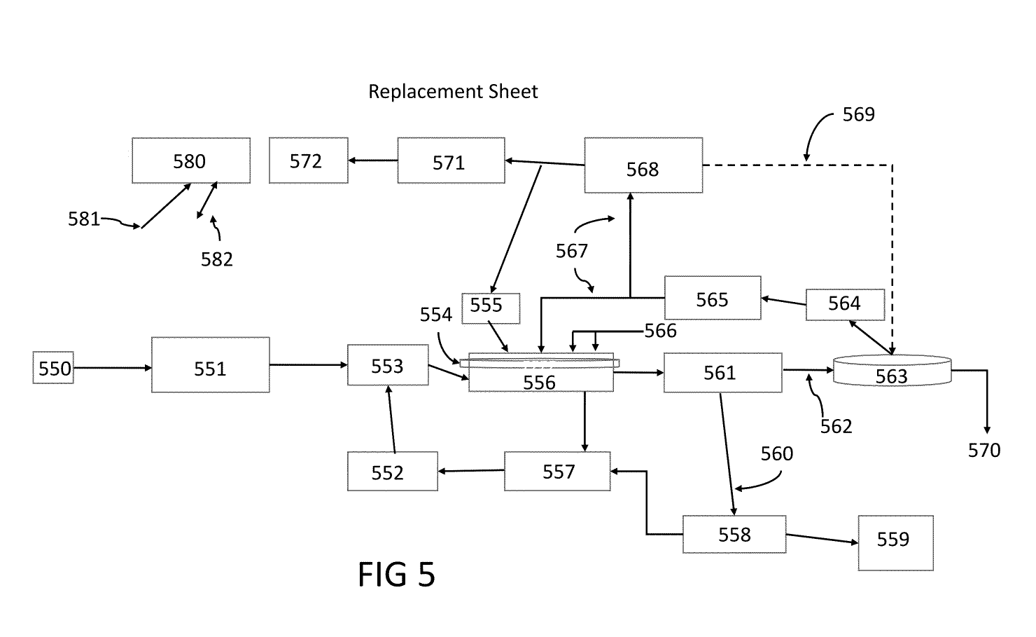

FIG. 5 depicts an embodiment of the process flow. The process has several stages, as described herein.

Prewash and Separation—551

This block takes the raw biomass 550 input to the machine. The biomass is then cleaned and checked for any large metal objects. A wash and metal detector will clean the biomass of rocks dirt and nuts bolts glass or metal cans. After the material has been cleaned it will start the preheat process in the Bulk Storage Feed System (BSF) 553. As the incoming material has been preheated 552 it will be pressed into the high pressure, temperature area of the TIPP reactor 556.

Bulk Storage Feed System (BSF)—553

The BSF preheats the biomass, adds water to the mix, and compacts the mixture to feed it into the high pressure plunger gate. Heat will be moved from the tail end of the TIPP reactor, where the biomass has been finished, to the BSF where it preheats the feedstock Using recycled heat from the tail end of the TIPP reactor will make the process more energy efficient.

Thermal Integrated Plug Pipe (TIPP)—554

The TIPP takes in high moisture content Biomass; heat's it at high pressure and temperature while continuously moving it through a pipe to produce biomass to char. The TIPP reactor is a plug flow reactor made from corrosion resistant pipe that will handle the high pressure 600 psi and temperature up to 600 F. The pipe can be a long as 30 ft and as large as 8″ in diameter. Along the length the reactor pipe will have a series of holes to allow for steam injection, temperature sensing, product sampling, and pressure monitoring. On the in-feed side if the TIPP reactor, the raw material can be fed to the reactor using several processes. One possible approach would be a fixed progressive lead screw. By turning the lead screw with a hydraulic motor, large forces will be generated to force the material into a precession bore. Another possible feed mechanism could be a reciprocating lead screw. The screw when turning counter clockwise will pre-load the screw with material, then the screw will move forward to inject the material into the hot TIPP reactor. One other variation on this loading mechanism would be a hydraulic driven shuttle load lock. It will slide from center open, to side lock for each stroke of the lead screw that packs material into the reactor.

Heat and pressure will be maintained thru holes along the reactor length. As the material is moving down the TIPP reactor, High pressure/temperature steam and water will be injected to change the moisture content of the reactor. This injection of water and steam 567 will optimize the reaction rate and minimize the dwell time in the TIPP reactor. Sensors along the TIPP reactor will allow for process control and help process reaction consistency under changing conditions. As a means of creating uniformity of the process a section of the TIPP reactor can have a section of mixing baffles along the center line of the TIPP reactor. These baffles will mix the material to help temperature uniformity. To help with heat distribution in the TIPP a length of pipe running the long direction in the center of the reactor will help with steam injection uniformity.

Once the material is finished and thru the hot section of the reactor the char will enter the cooling/water separation section 561.

Water Extraction—561

The liquid separation consist of a hydraulic driven press that removes water from the slurry of char and residue. In this section the high pressure slurry will be forced thru a pellet die. By squeezing the water out of the char it will reduce the energy and time to dry the pellets. By squeezing the solids will also keep the char together and make it easier to handle once it is dry.

Heat Exchanger Recycler—568

Process heat from the tail of the reactor will be recycled via a working fluid to the head of the machine to preheat the feed stock. Moving heat from the tail of the reactor to the BSF will quickly cool the char and conserve energy. A tube shell or flat plate heat exchange can be used to transfer heat to the fluid. Hot exhaust gases from the steam generator combustion chamber can also be recycled and used to dry the pressed char pellets.

Water Purifier—558

Waste water or gray water from the water extractor 561 is processed by the water purifier 558. The condensate input will be passed thru a filter to capture the organic contaminates from the water and make the water safe for animal consumption. It will process up to 1000 gallons per hour, for example, in a preferred embodiment. In one embodiment, the filter may use activated carbon to remove water born organics and some water soluble salts. The filter material when contaminated can then be dried and burned in the steam generator.

The heat from the condenser will be moved up to the material feed section thru a working fluid. The solids rich hot slurry will be driven thru a pellet die with a hydraulic ram to squeeze the balance of the water out of the slurry and form pellets for the next drying step. The balance of the water at this step will also be filtered for animal consumption. The next process will be to dry the pellets so they are ready for bulk shipping.

Drying Chamber—563

The drying chamber will be a heated, sheet metal, insulated chamber that runs the length of the flatbed trailer with a conveyor belt to support the pellets. There could be two heat sources for the dryer, in one embodiment, though other configurations may be used. First the hot exhaust gasses from the solid fuel combustor steam generator will be blown over the top of the drying pellets on the conveyer. The second source of heat can be steam from the steam generator or reclaimed heat from the pellet press's hot water. Once the pellets are dry they will be augured into a bulk storage container. This container will protect the pellets from the weather and will be easy to load onto trucks for shipping to distribution centers.

Steam Generator—565

Char from the machine output will be fed back to a steam generator. The char will be burnt in a forced air combustion chamber that generates heat for the steam generator. The char will be fed to the combustion chamber with an auto auger. This steam will be used to heat the feedstock and reactor. The steam will also be fed to run a heat engine. This heat engine will drive an electrical generator and a hydraulic pump. The electrical generator will make the power to run the controller and valves. The hydraulic will be used to power all feed drives, pellet press, and conveyer drive.

Heat Engine 568/Electrical Generator 571/Batteries 572

The Heat Engine converts heat from the Steam Generator and in turn drives the DC Electrical Generator via a standard mechanical rotational interface. The resultant electrical power from the generator continuously charges the system battery bank. The battery bank's stored electrical power is configured to run all the subsystems including the Control Process System. In a preferred embodiment the battery bank will consist of lead acid, deep discharge batteries, designed to operate for 8 years and discharged to 50% of capacity during operation. The process control system will manage the charge and discharge of the bank thru a specialized lead acid battery management system.

Control System and Process—580

The Control System consists of a computer processing unit which runs a stored program. To execute the biomass to char conversion process. The interface to the control system includes temperature sensors, pressure sensors, moisture sensor, valves, switches and electric motors to control all the subsystems in the machine. The Control System has multiple process programs to convert biomass. Depending on the type of biomass, the user will enter the appropriate program via a GUI (graphic user interface) located on the machine. The GUI will show a menu to select the type of biomass to process.

The machine will run automatically once the instructions are entered into the machine. Further, in one embodiment the computer system consists of a Linux operating, connection to a data server in-the-cloud via remote satellite connection. The computer processing unit will have a weather harden, ruggedized box containing an advanced microcomputer that will analyze sensor inputs and send signals to manage subsystems. The battery bank will supply power to the control system for initial startup and during operation.

In a preferred embodiment the operating temperature of the ruggedized box shall be −20 to 70C.

The process computer program will run automatically, making it a continuous process, to manage the rate, temperature, moisture content and pressure in each subsystem. Signals from the computer processing unit will control BSF speed, the rate material is moving through the TIPP, the rate of combustion in the steam generator, electrical, and battery storage, temperature of the drying chamber (to decide dry time), char rate out steam to the TIPP and water flow.

The process computer program will operate the machine to process biomass in the following steps:

Biomass is inserted into the Prewash. At Prewash the biomass is sprayed with processed water and then the non-organic solids are separated from the biomass.

From step one the biomass is conveyed to the bulk storage feeder (BSF). The material Auger's speed is controlled by the computer program. The feed stock's condition is monitored for moisture content, torque, and pressure are measured at the hydraulic motor that drives the lead screw. Load material feed to TIPP via lead screw, (three different to do it).

Biomass goes into the front of the TIPP via the BSF lead screw. It is then pushed with a ram cylinder down to the opening of the TIPP thru a gate valve. By driving a RAM piston that forces the material into the TIPP pressure is maintained in the TIPP. As the Ram starts moving forward there is a gate valve that shuttles side to side open and close, thereby keeping the material in the TIPP and holding pressure.

Once the material is in the TIPP it will be pre-heated by injecting steam at a pressure and temperature that brings the biomass up to cooking temperature and pressure in a short period of time. Band heaters along the TIPP will be used to supper heat the biomass and keep the temperature stable while the material moves down the TIPP. The TIPP will be insulated to keep the heat in the TIPP. The biomass at the exit point is carbonatious slurry material.

The BTU content of the final product material is based on the cooking time and temperature. With this method the energy quality of a particular biomass material can be controlled. Any type of biomass could be processed by dialing in a setting at the control system display.

Further this method can, with a single control algorithm, process any type of biomass with a single set point on the TIPP. The biomass then flows to the liquid/solids extractor it is metered out of the TIPP by meter screw, an auger, taking the material at high temperature, high pressure back to an atmospheric low temperature material.

The liquid is removed by pressing and squeezing out the water from the slurry. The mechanization is a similar approach used in ramming the material into the TIPP. The operation consists of a reverse RAM that squeezes the water out of the slurry. Finally the resultant char material is run through an automated pellet press.

The char may then go to a dryer chamber and the water is routed to a water purifier.

Char output is shuttled to a bin for distribution.

In a preferred embodiment, 10% of Char is moved to the Steam generator to be combusted and used for energy in driving the system, for example.

Although there have been described preferred embodiments of this system, many variations and modifications are possible in light of the above teachings and may be practiced otherwise than as specifically described while within the scope of the appended claims. The embodiments described herein are not limited by the specific disclosure above, but rather should be limited only by the scope of the appended claims and their equivalents.

For example, the target system need not be portable or may be on a train system or other portable transportation.

1. A method for producing a biochar mass comprising the steps of:
introducing a biomass to a reactor; and
heating the biomass in the reactor in accordance with a predetermined set of operating parameters attuned to the biomass to produce a stable biochar core, wherein said heating is done in an aqueous solution under oxygen deficient conditions.

2. The method of claim 1, wherein the biomass includes a plant derived material and/or an animal product.

3. The method of claim 1, wherein the predetermined set of operating parameters includes a time-dependent temperature profile that corresponds to the selected type of biochar core.

4. The method of claim 1, wherein the predetermined set of operating parameters includes an established temperature range and rate of temperature change that corresponds to the selected type of biochar core.

5. The method of claim 1, further comprising at least one of blending the biochar core with organic matter, annealing, or activation.

6. The method of claim 1, further comprising mixing the biochar with a supplement to produce a functionalized biochar core.

7. The method of claim 6, wherein the supplement includes a microbe, a nutrient, a fertilizer, or any combination thereof.

8. The method of claim 7, wherein the supplement includes nutrients comprising nitrogen, phosphorus, potassium, selenium, cobalt, iron, or manganese.

9. The method of claim 1 wherein the reactor is sized to be movable via common roadways.

10. The method of claim 1 wherein the biochar has a rate of degradation that is less than 2.5% per year, and is determined by measuring the loss of carbon.

11. The method of claim 1 wherein said biomass is heated under oxygen-free conditions.

12. The method of claim 1 wherein the biomass is heated in a porous pipe wherein steam is injected into the pipe, the biomass is moved through said pipe in a continuous feed system, said operating parameters are a function of the heating conditions, the length of pipe, and composition of feedstock biomass.
